(19) United States
(12) Patent Application Publication
(10) Pub. No.: US 2022/0392202 A1
(43) Pub. Date: Dec. 8, 2022

(54) IMAGING PROCESSING METHOD AND APPARATUS, ELECTRONIC DEVICE, AND STORAGE MEDIUM

(71) Applicant: Shenzhen Sensetime Technology Co., Ltd., Guangdong (CN)

(72) Inventors: Jianbo Liu, Guangdong (CN); Sijie Ren, Guangdong (CN); Xiaogang Wang, Guangdong (CN); Hongsheng Li, Guangdong (CN)

(73) Assignee: Shenzhen Sensetime Technology Co., Ltd., Guangdong (CN)

(21) Appl. No.: 17/890,393

(22) Filed: Aug. 18, 2022

Related U.S. Application Data
(63) Continuation of application No. PCT/CN2020/099964, filed on Jul. 2, 2020.

(30) Foreign Application Priority Data
Feb. 28, 2020 (CN) 202010129399.9

(51) Int. Cl. G06V 10/77; G06V 10/42; G06V 10/82; G06V 10/80; G06V 10/26

(52) U.S. Cl. CPC G06V 10/7715; G06V 10/42; G06V 10/82; G06V 10/806; G06V 10/26

(57) ABSTRACT

The present disclosure relates to an image processing method and apparatus, an electronic device and a storage medium. The method includes performing feature extraction on an image to be processed to obtain a first feature map of the image to be processed and performing weight prediction on the first feature map to obtain a weight feature map of the first feature map. The weight feature map includes weight values of feature points in the first feature map. The method further includes performing feature value adjustment on the feature points in the first feature map based on the weight feature map to obtain a second feature map and determining a processing result of the image to be processed according to the second feature map. Embodiments of the present disclosure may improve the image processing accuracy.

### CROSS-REFERENCE TO RELATED APPLICATION

This application is a continuation application of International Application No. PCT/CN2020/099964 filed on Jul. 2, 2020, which claims priority of Chinese Patent Application entitled “Image Processing Method and Apparatus, Electronic Device, and Storage Medium” filed to the CNIPA on Feb. 28, 2020 with the Application No. 202010129399.9, the entire contents of which are hereby incorporated by reference.

### TECHNICAL FIELD

The present disclosure relates to the technical field of computers, and particularly to an image processing method and apparatus, an electronic device and a storage medium.

### BACKGROUND

In fields such as computer vision and the like, it is usually necessary to process images.

In image processing methods of related art, generally, feature maps of the images may be extracted, and object information in a scene of an image is analyzed according to the feature maps, thereby obtaining an image processing result.

### SUMMARY

The present disclosure provides an image processing technical solution.

According to one aspect of the present disclosure, there is provided an image processing method, which includes: performing feature extraction on an image to be processed to obtain a first feature map of the image to be processed; performing weight prediction on the first feature map to obtain a weight feature map of the first feature map, where the weight feature map includes weight values of feature points in the first feature map; performing feature value adjustment on the feature points in the first feature map according to the weight feature map to obtain a second feature map; and determining a processing result of the image to be processed according to the second feature map.

In a possible implementation, the performing weight prediction on the first feature map to obtain the weight feature map of the first feature map includes: performing convolution kernel prediction on each channel of the first feature map to determine a first convolution kernel tensor of the first feature map, where the number of channels of the first convolution kernel tensor is the same as the number of channels of the first feature map, and a length and width of the first convolution kernel tensor correspond to a preset size of the convolution kernel; and performing convolution processing on the first feature map according to the first convolution kernel tensor to obtain the weight feature map.

In a possible implementation, the performing convolution processing on the first feature map according to the first convolution kernel tensor to obtain the weight feature map includes: performing dilated convolution on the first feature map according to the first convolution kernel tensor of the first feature map and a plurality of preset dilation rates to obtain a plurality of fourth feature maps of the first feature map; activating respectively the plurality of fourth feature maps to obtain a plurality of fifth feature maps; and determining the weight feature map of the first feature map according to the plurality of fifth feature maps.

In a possible implementation, the performing convolution kernel prediction on each channel of the first feature map to determine the first convolution kernel tensor of the first feature map includes: performing convolution transform respectively on the first feature maps to obtain key feature maps and query feature maps of the first feature maps, where a dimension of the key feature map is the same as a dimension of the first feature map, a length and width of the query feature map are the same as the length and width of the first feature map, and the number of channels of the query feature map corresponds to a size of the convolution kernel; performing rearrangement respectively on the key feature maps and the query feature maps to obtain a first feature matrix of the key feature maps and a second feature matrix of the query feature maps; performing matrix multiplication on the first feature matrix and the second feature matrix to obtain a third feature matrix of the first feature map; and determining the first convolution kernel tensor of the first feature map according to the third feature matrix.

In a possible implementation, the determining the first convolution kernel tensor of the first feature map according to the third feature matrix includes: performing rearrangement on the third feature matrix to obtain a second convolution kernel tensor of the first feature map; and performing normalization on the second convolution kernel tensor to determine the first convolution kernel tensor of the first feature map.

In a possible implementation, the performing feature value adjustment on the feature points in the first feature map according to the weight feature map to obtain the second feature map includes: performing element multiplication on the first feature map and the weight feature map to obtain the second feature map.

In a possible implementation, the method further includes: performing global pooling on the first feature map to obtain a pooled feature map of the first feature map, where a dimension of the pooled feature map is the same as the dimension of the first feature map;

The determining a processing result of the image to be processed according to the second feature map includes: performing fusion on the second feature map and the pooled feature map to obtain a fused feature map; and performing segmentation on the fused feature map to obtain the processing result of the image to be processed.

In a possible implementation, the performing global pooling on the first feature map to obtain the pooled feature map of the first feature map includes: performing pooling on the first feature map to obtain a first vector of the first feature map; performing convolution on the first vector to obtain a second vector; and performing upsampling on the second vector to obtain the pooled feature map of the first feature map.

In a possible implementation, the determining a processing result of the image to be processed according to the second feature map includes: performing segmentation on the second feature map to obtain the processing result of the image to be processed.

According to one aspect of the present disclosure, there is provided an image processing apparatus, which includes: a processor; and a memory configured to store processor executable instructions, wherein the processor is configured to call the instructions stored in the memory to execute the method of: performing feature extraction on an image to be processed to obtain a first feature map of the image to be processed; performing weight prediction on the first feature map to obtain a weight feature map of the first feature map, the weight feature map including weight values of feature points in the first feature map; performing feature value adjustment on the feature points in the first feature map according to the weight feature map to obtain a second feature map; and determining a processing result of the image to be processed according to the second feature map.

In a possible implementation, the weight prediction includes: performing convolution kernel prediction on each channel of the first feature map to determine a first convolution kernel tensor of the first feature map, where the number of channels of the first convolution kernel tensor is the same as the number of channels of the first feature map, and a length and width of the first convolution kernel tensor correspond to a preset size of the convolution kernel; and performing convolution processing on the first feature map according to the first convolution kernel tensor to obtain the weight feature map.

In a possible implementation, the performing the convolution processing to obtain the weight feature map includes: performing dilated convolution on the first feature map according to the first convolution kernel tensor of the first feature map and a plurality of preset dilation rates to obtain a plurality of fourth feature maps of the first feature map; activating respectively the plurality of fourth feature maps to obtain a plurality of fifth feature maps; and determining the weight feature map of the first feature map according to the plurality of fifth feature maps.

In a possible implementation, the convolution kernel prediction includes: performing convolution transform respectively on the first feature maps to obtain key feature maps and query feature maps of the first feature maps, where a dimension of the key feature map is the same as a dimension of the first feature map, a length and width of the query feature map are the same as the length and width of the first feature map, and the number of channels of the query feature map corresponds to the size of the convolution kernel; performing rearrangement respectively on the key feature maps and the query feature maps to obtain a first feature matrix of the key feature maps and a second feature matrix of the query feature maps; performing matrix multiplication on the first feature matrix and the second feature matrix to obtain a third feature matrix of the first feature map; and determining the first convolution kernel tensor of the first feature map according to the third feature matrix.

In a possible implementation, the determining the first convolution kernel tensor includes: performing rearrangement on the third feature matrix to obtain a second convolution kernel tensor of the first feature map; and performing normalization on the second convolution kernel tensor to determine the first convolution kernel tensor of the first feature map.

In a possible implementation, the performing feature value adjustment on the feature points in the first feature map includes: performing element multiplication on the first feature map and the weight feature map to obtain the second feature map.

In a possible implementation, the processor is configured to call the instructions to further perform global pooling on the first feature map to obtain a pooled feature map of the first feature map, where a dimension of the pooled feature map is the same as the dimension of the first feature map.

The determining a processing result of the image to be processed includes: performing fusion on the second feature map and the pooled feature map to obtain a fused feature map; and performing segmentation on the fused feature map to obtain the processing result of the image to be processed.

In a possible implementation, the performing global pooling includes: performing pooling on the first feature map to obtain a first vector of the first feature map; performing convolution on the first vector to obtain a second vector; and performing upsampling on the second vector to obtain the pooled feature map of the first feature map.

In a possible implementation, the determining a processing result of the image to be processed includes: performing segmentation on the second feature map to obtain the processing result of the image to be processed.

According to one aspect of the present disclosure, there is provided an electronic device, which includes a processor and a memory configured to store processor executable instructions, wherein the processor is configured to call the instructions stored in the memory to execute the above method.

According to one aspect of the present disclosure, there is provided a computer readable storage medium having computer program instructions stored thereon, wherein the computer program instructions, when executed by a processor, implement the above.

According to one aspect of the present disclosure, there is provided a computer program product, which includes computer-readable codes; and when the computer readable codes are run in an electronic device, a processor in the electronic device executes the above method.

In the embodiments of the present disclosure, weight prediction can be performed on the feature map of the image to be processed to obtain the weight feature map including the weight values of the feature points in the feature map; the feature points in the feature map can be adjusted according to the weight feature map; and the processing result of the image can be determined according to the adjusted feature map, so that the image feature information is enhanced through the weight values that are not shared globally, and the image processing accuracy is improved.

It will be appreciated that the above general descriptions and detailed descriptions below are only exemplary and explanatory and not intended to limit the present disclosure. Other features and aspects of the present disclosure will be apparent according to the following detailed description made on the exemplary embodiments with reference to the accompanying drawings.

### BRIEF DESCRIPTION OF THE DRAWINGS

The accompanying drawings, which are incorporated in and constitute a part of the present description, illustrate embodiments consistent with the present disclosure and serve to explain the technical solutions of the present disclosure together with the description.

FIG. 1 illustrates a flow chart of an image processing method according to an embodiment of the present disclosure.

FIG. 2 illustrates a schematic diagram of a process of the image processing method according to an embodiment of the present disclosure.

FIG. 3 illustrates a block diagram of an image processing apparatus according to an embodiment of the present disclosure.

FIG. 4 illustrates a block diagram of an electronic device according to an embodiment of the present disclosure.

FIG. 5 illustrates a block diagram of an electronic device according to an embodiment of the present disclosure.

### DETAILED DESCRIPTION

Various exemplary embodiments, features and aspects of the present disclosure are described in detail below with reference to the accompanying drawings. Reference signs in the drawings indicate elements with same or similar functions. Although various aspects of the embodiments are illustrated in the drawings, the drawings are unnecessary to draw to scale unless otherwise specified.

The term “exemplary” herein means “using as an example and an embodiment or being illustrative”. Any embodiment described herein as “exemplary” should not be construed as being superior or better than other embodiments.

The term “and/or” used herein is only an association relationship for describing associated objects, which means that there may be three relationships, for example, A and/or B may mean three situations: A exists alone, both A and B exist, and B exists alone. Furthermore, the item “at least one of ” herein means any one of a plurality of or any combinations of at least two of a plurality of, for example, “including at least one of A, B and C” may represent including any one or more elements selected from a set consisting of A, B, and C.

Furthermore, for better describing the present disclosure, numerous specific details are illustrated in the following detailed description. Those skilled in the art should understand that the present disclosure may be implemented without certain specific details. In some examples, methods, means, elements and circuits that are well known to those skilled in the art are not described in detail in order to highlight the main idea of the present disclosure.

In fields of smart video analysis, smart medical care, autonomous driving, etc., it is usually necessary to process images to identify targets in the images. For example, in autonomous driving scenarios, it is usually necessary to identify target objects such as cars, pedestrians, lane lines and the like in a vehicle scenario and make segmentation to implement a smart sensing task of a vehicle scenario. In order to improve the image processing accuracy, the image feature information may be enhanced through the weight values that are not shared globally during image processing.

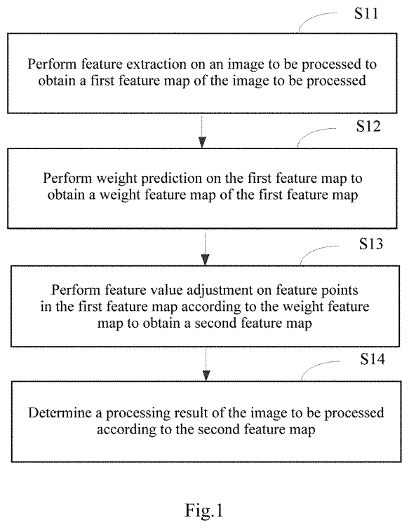

FIG. 1 illustrates a flow chart of an image processing method according to an embodiment of the present disclosure. As shown in FIG. 1, the method includes:

In step S11, feature extraction is performed on an image to be processed to obtain a first feature map of the image to be processed;

In step S12, weight prediction is performed on the first feature map to obtain a weight feature map of the first feature map, and the weight feature map includes weight values of feature points in the first feature map;

In step S13, feature value adjustment is performed on the feature points in the first feature map according to the weight feature map to obtain a second feature map;

In step S14, a processing result of the image to be processed is determined according to the second feature maps.

In a possible implementation, the image processing method may be executed by an electronic device such as a terminal device or a server. The terminal device may be user equipment (UE), a mobile device, a user terminal, a terminal, a cellular phone, or a cordless telephone, a personal digital assistant (PDA), a handheld device, a computing device, a vehicle-mounted device, a wearable device, etc. The method may be implemented by a processor invoking a computer readable instruction stored in a memory. Or the method may be executed by the server.

In a possible implementation, the image to be processed may be an image acquired by an image acquisition device (such as a camera). The image includes one or more targets to be identified, such as humans, animals, vehicles, articles, etc. The present disclosure does not limit the source of the image to be processed and a specific category of the target in the image to be processed.

In a possible implementation, in step S11, for example, feature extraction may be performed on the image to be processed through a convolutional neural network to obtain the first feature map X of the image to be processed. The first feature map may reflect the feature information (such as semantic information) of each pixel position in the image to be processed, so that all pixel positions in the image to be processed are classified according to the feature information in the subsequent processing. The convolutional neural network may be, for example, a residual network (ResNet), and the present disclosure does not limit a specific network structure of the convolutional neural network.

In a possible implementation, in step S12, weight prediction may be performed on the first feature map to predict a weight value (which may also be referred to as a weight factor or a weight weighting factor) for the feature point in the first feature map and to obtain the weight feature map W of the first feature map X.

In a possible implementation, each point in the weight feature map W may correspond to the weight value of each feature point in the first feature map X. For example, the weight feature map W has the same dimension as the first feature map X. For example, the dimension of the first feature map X is h×w×c, and the dimension of the weigh feature map W is also h×w×c, where h and w represent height and width, and c represents the number of channels; for example, c is 512.

In a possible implementation, each point in the weight feature map W may also correspond to the weight values of a plurality of feature points in the first feature map X, that is, the weight values are shared partially, and the dimension of the weight feature map W is smaller than the dimension of the first feature map X. For example, the dimension of the weight feature map W is (h/2)×(w/2)×c, and each point in the weight feature map W corresponds to the weight values of four points in a 2×2 region in the first feature map X.

In a possible implementation, the feature point in the weight feature map W may also correspond to the weight values of some feature points in the first feature map X, that is, some feature points in the first feature map X have weight values, and the dimension of the weight feature map W is smaller than the dimension of the first feature map X. For example, the dimension of the weight feature map W is (h/2)×(w/2)×c, and the weight value of a certain point of the 2×2 region in the first feature map X corresponds to the point in the weight feature map W.

The present disclosure does not limit the dimension of the weight feature map W, and the correspondence between the weight value of each point in the weight feature map W and the feature point in the first feature map X.

In a possible implementation, in step S13, weighting may be performed on the first feature map X according to the weight feature map W, and the feature value of the feature point in the first feature map may be adjusted to obtain an adjusted second feature map. A dimension of the second feature map is the same as the dimension of the first feature map X.

In a possible implementation, in step S14, the processing result of the image to be processed may be determined according to the second feature map. Segmentation may be performed directly on the second feature map to obtain a segmentation result; or the second feature map may be further processed, and segmentation may be performed on the processed feature map to obtain the segmentation result.

Further, the processing result of the image to be processed may be obtained. The processing result may be the above segmentation result, or may be a result obtained by re-processing the above segmentation result according to a practical image processing task. For example, in an image editing task, a foreground region and a background region may be distinguished according to the segmentation result, and the foreground region and/or the background region may be processed accordingly, for example, the background region may be blurred to obtain the final image processing result. The present disclosure does not limit the specific manner of segmentation of the feature map and the specific content included in the processing result.

According to an embodiment of the present disclosure, weight prediction can be performed on the feature map of the image to be processed to obtain the weight feature map including the weight values of the feature points in the feature map; the feature points in the feature map are adjusted according to the weight feature map; and the processing result of the image is determined according to the adjusted feature map, so that the image feature information is enhanced through the weight values that are not shared globally, and the image processing accuracy is improved.

In a possible implementation, after the first feature map of the image to be processed is extracted in step S11, weight prediction may be performed on the first feature map in step S12, wherein step S12 may include:

convolution kernel prediction is performed on each channel of the first feature map to determine a first convolution kernel tensor of the first feature map, where the number of channels of the first convolution kernel tensor is the same as the number of channels of the first feature map, and a length and a width of the first convolution kernel tensor correspond to a preset size of the convolution kernel; and

convolution processing is performed on the first feature map according to the first convolution kernel tensor to obtain the weight feature map.

For example, the first feature map may reflect the feature information (such as semantic information) of each pixel position in the image to be processed. The first feature map has multiple channels, for example, 512 channels (c=512). Feature-adaptive convolution kernel prediction may be performed according to the number of channels of the first feature map to determine the first convolution kernel tensor of the first feature map. The first convolution kernel tensor includes the convolution kernels of all the predicted channels. Therefore, the number of channels of the first convolution kernel tensor is the same as the number of channels of the first feature map. The length and the width of the first convolution kernel tensor correspond to the preset size s×s of the convolution kernel. The size of the convolution kernel may be, for example, 3×3, and the length and the width of the first convolution kernel tensor may be 3 respectively. It should be understood that those skilled in the art may set a value of the dimension s×s of the convolution kernel according to the practical situation, which is not limited in the present disclosure.

In a possible implementation, the step in which convolution kernel prediction is performed on each channel of the first feature map to determine the first convolution kernel tensor of the first feature map may include:

convolution transform is performed respectively on the first feature maps to obtain key feature maps and query feature maps of the first feature maps, where the dimension of the key feature map is the same as the dimension of the first feature map, a length and width of the query feature map are the same as the length and width of the first feature map, and the number of channels of the query feature map corresponds to the size of the convolution kernel;

rearrangement is performed respectively on the key feature maps and the query feature maps to obtain a first feature matrix of the key feature maps and a second feature matrix of the query feature maps;

matrix multiplication is performed on the first feature matrix and the second feature matrix to obtain a third feature matrix of the first feature map; and

the first convolution kernel tensor of the first feature map is determined according to the third feature matrix.

For example, convolution transforms Tₖ and T_{q} may be preset, and the convolution transforms Tₖ and T_{q} each is composed of one or more 1×1 convolution operations and is independent of each other. The present disclosure does not limit the specific manner of the convolution transform.

In a possible implementation, transform may be performed on the first feature map through the convolution transform Tₖ to obtain the key feature map K. The key feature map K can derive c pieces of different key feature information of the first feature map. The dimension of the key feature map K is the same as the dimension of the first feature map, that is, h×w×c.

In a possible implementation, transform may be performed on the first feature map through the convolution transform T_{q} to obtain the query feature map Q. The global spatial distribution information of the first feature map may be extracted from the query feature map Q. The length and the width of the query feature map Q are the same as the length and the width of the first feature map, i.e., h×w; and the number of channels corresponds to the size of the convolution kernel, i.e., s×s. For example, when the size of the convolution kernel is 3×3, the number of channels of the query feature map Q is 9.

In a possible implementation, rearrangement may be performed respectively on the key feature maps K and the query feature maps Q to obtain a first feature matrix K̅ of the key feature maps and a second feature matrix [symbol] of the query feature maps, wherein the dimension of the first feature matrix K̅ is n×c, and n=h×w; and the dimension of the second feature matrix [symbol] is n×s².For example, when the dimension h×w×c of the first feature map is 64×64×512, and the size s×s of the convolution kernel is 3×3, the dimension of the first feature matrix K̅ is 4096×512; and the dimension of the second feature matrix [symbol] is 4096×9.

In a possible implementation, matrix multiplication may be performed on the first feature matrix K̅ and the second feature matrix [symbol] to obtain the third feature matrix D̅ of the first feature map:

$$\overline{D} = {\overline{Q}}^{T} \overline{K} \qquad ( 1 )$$

In the formula (1), [symbol] the transposition of the second feature matrix [symbol] ; and the dimension of the third feature matrix D̅ is s²×c. When s=3 and c=512, the dimension of the third feature matrix D̅ is 9×512.

In a possible implementation, the first convolution kernel tensor of the first feature map may be determined according to the third feature matrix, wherein rearrangement may be performed on the third feature matrix to obtain a three-dimensional tensor with the dimension of s×s×c, and the tensor is used directly as the first convolution kernel tensor; and the rearranged three-dimensional tensor may be further processed to obtain the first convolution kernel tensor.

In this way, the convolution kernels of all channels of the first feature map can be predicted with relatively low operational complexity, thereby improving the processing efficiency.

In a possible implementation, the step in which the first convolution kernel tensor of the first feature map is determined according to the third feature matrix may include:

rearrangement is performed on the third feature matrix to obtain a second convolution kernel tensor of the first feature map; and normalization is performed on the second convolution kernel tensor to determine the first convolution kernel tensor of the first feature map.

For example, rearrangement may be performed on the third feature matrix D̅, and the matrix with the dimension of s²×c is rearranged into a three-dimensional tensor with the dimension of s×s×c, which may be referred to as the second convolution kernel tensor; and then normalization, such as batch normalization (BN), is performed on the second convolution kernel tensor, and the normalized three-dimensional tensor is used as the first convolution kernel tensor. In this way, the obtained convolution kernel tensor may be standardized.

In a possible implementation, the step in which convolution processing is performed on the first feature map according to the first convolution kernel tensor to obtain the weight feature map may include:

dilated convolution is performed on the first feature map according to the first convolution kernel tensor of the first feature map and a plurality of preset dilation rates to obtain a plurality of fourth feature maps of the first feature map;

the plurality of fourth feature maps are activated respectively to obtain a plurality of fifth feature maps; and

the weight feature map of the first feature map is determined according to the plurality of fifth feature maps.

For example, a plurality of dilation rates of the dilated convolution may be preset, for example, the dilation rates are 1, 2, and 3; dilated convolution is performed respectively on the first feature map according to the first convolution kernel tensor and the plurality of dilation rates to obtain a plurality of fourth feature maps of the first feature map, and the number of the fourth feature maps is the same as the number of the dilation rates. For example, the size of the convolution kernel is 3×3, the dilation rates are 1, 2, and 3, and the feature regions of each convolution operation are 3×3, 5×5, and 7×7 respectively. It should be understood that those skilled in the art may set the number of dilation rates of the dilated convolution according to the practical situation, which is not limited in the present disclosure.

In a possible implementation, the dimension of the fourth feature map is the same as the dimension of the first feature map. That is, in a case where each point in the weight feature map W corresponds to the weight value of each feature point in the first feature map X, the dimension of the fourth feature map is equal to the dimension of the first feature map, i.e., h×w×c.

In a possible implementation, the dimension of the fourth feature map is smaller than the dimension of the first feature map. That is, in a case where each point in the weight feature map W corresponds to the weight values of a plurality of feature points in the first feature map X, the dimension of the fourth feature map is smaller than the dimension of the first feature map X, for example, (h/2)×(w/2)×c. In this way, the calculation amount in the image processing process can be reduced.

In a possible implementation, the step in which dilated convolution is performed on the first feature map according to the first convolution kernel tensor of the first feature map and a plurality of preset dilation rates to obtain a plurality of fourth feature maps of the first feature map includes:

the first feature map is cropped to obtain a cropped first feature map; and

dilated convolution is performed respectively on the cropped first feature map according to the first convolution kernel tensor and a plurality of preset dilation rates to obtain a plurality of fourth feature maps of the first feature map.

That is, in a case where the feature point in the weight feature map W corresponds to the weight values of some feature points in the first feature map X, the first feature map X may be cropped first to keep some feature points whose weight values are to be generated. Dilated convolution is performed on the cropped first feature map according to the first convolution kernel tensor and a plurality of preset dilation rates, to obtain a plurality of fourth feature maps of the first feature map. In this case, the dimension of the obtained fourth feature map is smaller than the dimension of the first feature map, for example, (h/2)×(w/2)×c. In this way, the weight values of some feature points in the first feature map can be acquired, thereby reducing the calculation amount in the image processing process.

In a possible implementation, the plurality of fourth feature maps may be activated respectively through a Sigmoid activation layer to obtain a plurality of activated fifth feature maps; and after element addition and averaging are performed on the plurality of fifth feature maps, the weight feature map W of the first feature map may be obtained.

In this way, the convolution region corresponding to the feature points of the feature map can be enlarged, so that each weight value in the weight feature map senses more global information, thereby improving the accuracy of each weight value.

In a possible implementation, after the weight feature map W is obtained, the first feature map X may be adjusted, wherein step S13 may include: element multiplication is performed on the first feature map and the weight feature map to obtain the second feature map. That is, point multiplication (element multiplication) is performed on the first feature map X and the weight feature map W, so as to implement weighting adjustment on the feature values of all or some feature points in the first feature map to obtain the weighted second feature map X*.

In this way, the feature enhancement of the feature map can be achieved, and the effect of subsequent image processing can be improved.

In a possible implementation, the method further includes:

global pooling is performed on the first feature map to obtain a pooled feature map of the first feature map, and a dimension of the pooled feature map is the same as the dimension of the first feature map.

Therein step S14 includes: fusion is performed on the second feature map and the pooled feature map to obtain a fused feature map; and segmentation is performed on the fused feature map to obtain the processing result of the image to be processed.

For example, the method may also include the global pooling branch, which is used to perform global pooling on the first feature map to obtain the pooled feature map, for participation in the subsequent image segmentation together with the weighted second feature image. The dimension of the pooled feature map may be the same as the dimension of the first feature map.

In a possible implementation, the step in which global pooling is performed on the first feature map to obtain the pooled feature map of the first feature map includes:

pooling is performed on the first feature map to obtain a first vector of the first feature map;

convolution is performed on the first vector to obtain a second vector; and

upsampling is performed on the second vector to obtain the pooled feature map of the first feature map.

That is, global pooling may also be performed on the first feature map through a set pooling branch network. The pooling network may include a pooling layer (Pool), a convolutional layer (Cony), and an upsampling layer (Upsample). Global pooling may be performed on the first feature map through the pooling layer to obtain the first vector; convolution is performed on the first vector through the convolutional layer, and the dimension of the vector is adjusted to obtain the second vector; and upsampling is performed on the second vector through the upsampling layer, and the dimension of the second vector is increased, thereby obtaining the pooled feature map having the same dimension as the first feature map. The present disclosure does not limit the specific network structure of the pooling branch network.

In a possible implementation, in step S14, fusion may be performed on the second feature map and the pooled feature map to obtain a fused feature map. The fusion may be performed by splicing or element addition. If the splicing is adopted, the dimension of the obtained fused feature map is h×w×2c, that is, the number of channels of the fused feature map is twice of the first feature map; and if the element addition is adopted, the dimension of the obtained fused feature map is h×w×c, that is, the dimension of the fused feature map is the same as the first feature map.

In a possible implementation, segmentation may be performed on the fused feature map through a preset segmentation network to obtain a segmentation result of the image to be processed, i.e., to divide the regions corresponding to humans or objects in various categories in the image. The segmentation network may include a convolutional layer, a pooling layer, a fully connected layer, etc. The present disclosure does not limit a specific network structure of the segmentation network.

In a possible implementation, the segmentation result may be used as the processing result of the image; and the segmentation result may be further processed to obtain the processing result of the image, which is not limited in the present disclosure.

In this way, the global information of the original feature map may be reserved, thereby improving the robustness of the processing result of the image.

In a possible implementation, step S14 may include: segmentation is performed on the second feature map to obtain the processing result of the image to be processed. That is, the second feature map may be segmented directly through the preset segmentation network to obtain the segmentation result of the image to be processed. Further, the segmentation result may be used as the processing result of the image; and the segmentation result may be further processed to obtain the processing result of the image. In this way, the accuracy of the image processing result may be improved. The segmentation network may be, for example, a convolutional neural network. The present disclosure does not limit a network structure of the segmentation network.

In a possible implementation, the first feature map may include semantic information of the image to be processed, which is used to represent the categories (such as humans, animals, vehicles, and other categories) of various positions in the image. After the processing in the steps S12-S13, the semantically-enhanced second feature map may be obtained. By understanding the semantic information of the image scenario, a specific object category is determined for each pixel, and semantic segmentation is further performed on the semantically-enhanced second feature map or fused feature map in step S14, so that a more accurate semantic segmentation result may be obtained.

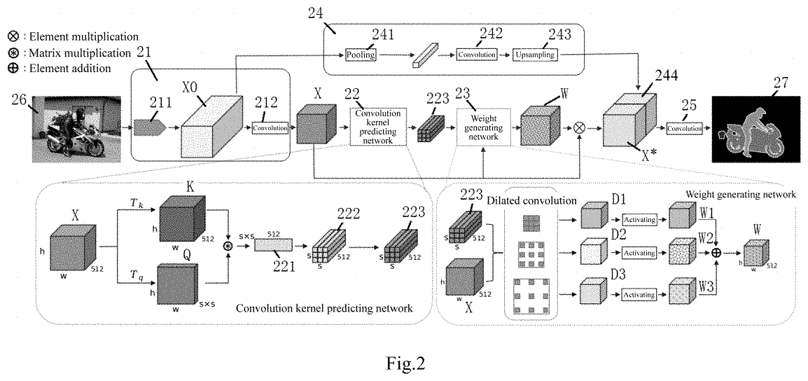

FIG. 2 illustrates a schematic diagram of a process of the image processing method according to an embodiment of the present disclosure. As shown in FIG. 2, the method may be implemented through the neural network. The neural network may include a feature extracting network 21, a convolution kernel predicting network 22, a weight generating network 23, a pooling branch network 24, and a segmentation network 25.

In an example, an image 26 to be processed (the dimension is, for example, H₀×W₀×C₀) may be inputted into a residual subnetwork 211 of the feature extracting network 21 for feature extraction to obtain a feature map X0, whose dimension is h×w×2048, where h=H₀/8, and w=W₀/8; and the feature map X0 is inputted into a convolutional subnetwork 212 of the feature extracting network 21 for convolution, the dimension of the feature map X0 is adjusted to obtain the first feature map X, and the dimension is h×w×512.

In an example, the first feature map X is inputted into the convolution kernel predicting network 22. Transform is performed on the first feature map X through convolution transforms Tₖ and T_{q} respectively to obtain key feature maps K (the dimension is h×w×512) and query feature maps Q (the dimension is h×w×(s×s)); rearrangement is performed respectively on the key feature maps K and the query feature maps Q to obtain a first feature matrix (not shown) of the key feature maps and a second feature matrix (not shown) of the query feature maps; matrix multiplication is performed on the first feature matrix and the second feature matrix to obtain a third feature matrix 221 (the dimension is (s×s)×512) of the first feature map; the third feature matrix 221 is rearranged to obtain a three-dimensional tensor 222 with the dimension of s×s×512; and batch normalization (BN) is performed on the three-dimensional tensor 222 to obtain the first convolution kernel tensor 223 (the dimension is s×s×512).

In an example, the first feature map X and the first convolution kernel tensor 223 are inputted into the weight generating network 23, and dilated convolution is performed on the first feature map X according to the first convolution kernel tensor 223 and a plurality of dilation rates respectively (the dilation rates in FIG. 2 are 1, 2, and 3) to obtain three fourth feature maps D1, D2, and D3 of the first feature map X; and the fourth feature maps D1, D2, and D3 are activated respectively by a Sigmoid activation layer of the weight generating network 23 to obtain fifth feature maps W1, W2, and W3; and element addition and averaging are performed respectively on the fifth feature maps W1, W2, and W3 to obtain the weight feature map W (the dimension is h×w×512).

In an example, element multiplication is performed on the first feature map X and the weight feature map W to obtain a second feature map X*, thereby achieving semantic feature enhancement of the feature map.

In an example, as shown in FIG. 2, the feature map X0 is inputted into the pooling branch network 24 for processing successively through the pooling layer 241, the convolutional layer 242, and the upsampling layer 243 of the pooling branch network 24 to obtain the pooled feature map 244 (the dimension is h×w×512). Splicing is performed on the second feature map X* and the pooled feature map 244 to obtain a fused feature map (the dimension is h×w×1024).

In an example, the segmentation network 25 is a convolutional neural network and includes a convolutional layer, a pooling layer, a fully connected layer, etc. The fused feature map is inputted into the segmentation network 25 for segmentation, which may derive a distribution probability map of each category, thereby obtaining a segmentation result 27 of the image 26 to be processed. As shown in FIG. 2, the segmentation result 27 includes a motorcycle (the category is a vehicle), a rider (the category is a human), and a flowerpot (the category is an article), so that the accurate segmentation of the image 26 to be processed is realized.

In a possible implementation, prior to the deployment of the above neural network, the neural network may be trained. The image processing method according to the embodiments of the present disclosure further includes:

the neural network is trained according to a preset training set; the training set includes a plurality of sample images and labeled information of the plurality of sample images.

For example, the sample images in the training set may be inputted into the neural network for processing to obtain a sample processing result of the sample images; a loss of the neural network is determined according to a difference between the sample processing result of the sample images and the labeled information; network parameters of the neural network are adjusted reversely according to the loss; and through multiple iterations, when training conditions (such as network convergence) are satisfied, the trained neural network is obtained. In this way, the training process of the neural network may be implemented.

The image processing method according to the embodiments of the present disclosure can predict a weight factor (weight value) that is not shared globally for each feature point of the feature map of the image to be processed; feature re-weighting is performed on each feature point in the feature map according to the weight factor to achieve the semantic feature enhancement of the feature map; and segmentation is performed on the semantically-enhanced feature map to obtain a more accurate semantic segmentation result. The method can improve effectively the accuracy in identifying the object in a complex scenario, the same object of different sizes in the image, and different objects with similar appearance features in the image.

The method predicts the convolution kernel of each channel of the feature map by matrix operations, so that the operation complexity is reduced, and the semantically adaptive convolution kernel prediction with low memory consumption and low operation amount can be realized, thereby implementing rapidly the semantic enhancement of the feature map.

The image processing method according to the embodiments of the present disclosure can be applied to smart video analysis, smart medical care, autonomous driving, and other application fields, and can improve the target identification accuracy of the image. For example, the method may be applied to a smart sensing task in the autonomous driving scenario to identify and segment target objects in the scenes of vehicles such as cars, pedestrians, lane lines and the like, thereby implementing the smart sensing task of scenes of vehicles. For example, the method may be applied to the smart medical care scenario to intelligently extract contours of targets such as lesions from medical images, to assist the work of doctors and to improve the processing efficiency of the doctors.

In an example, the method may be applied to the detection and identification task of the image to effectively improve the unreasonable feature distribution in the semantic feature map and to obtain the semantic feature map with the global semantic information sensing capacity. The semantic feature map can improve the image detection and identification performance.

In an example, the method may be applied to the smart editing task of the images and videos to automatically identify different objects in the image and to adopt different image processing processes for different objects. For example, in a portrait function of a smart phone, it is necessary to perform blurring processing on the background of a figure to realize the photographing effect of a single-lens-reflex camera. The region of the figure in the image may be identified by the method, and the position outside the region of the figure is blurred.

It may be understood that the above method embodiments described in the present disclosure may be combined with each other to form combined embodiments without departing from principles and logics, which are not repeated in the present disclosure due to space limitation. It will be appreciated by those skilled in the art that the specific execution sequence of various steps in the above method of specific implementations shall be determined on the basis of their functions and potential intrinsic logics.

Furthermore, the present disclosure further provides an image processing apparatus, an electronic device, a computer-readable storage medium, and a program, all of which may be used to implement any image processing method provided by the present disclosure. For the corresponding technical solutions and descriptions, please refer to the corresponding description for the method part, which will not be repeated.

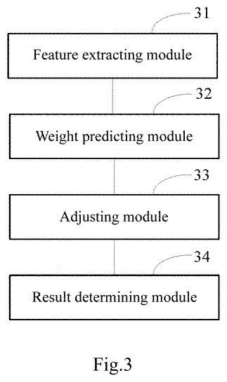

FIG. 3 illustrates a block diagram of an image processing apparatus according to an embodiment of the present disclosure. As shown in FIG. 3, the apparatus includes:

a feature extracting module 31, configured to perform feature extraction on an image to be processed to obtain a first feature map of the image to be processed; a weight predicting module 32, configured to perform weight prediction on the first feature map to obtain a weight feature map of the first feature map, where the weight feature map includes weight values of feature points in the first feature map; an adjusting module 33, configured to perform feature value adjustment on the feature points in the first feature map according to the weight feature map to obtain a second feature map; and a result determining module 34, configured to determine a processing result of the image to be processed according to the second feature map.

In a possible implementation, the weight predicting module includes: a convolution kernel predicting submodule, configured to perform convolution kernel prediction on each channel of the first feature map to determine a first convolution kernel tensor of the first feature map, where the number of channels of the first convolution kernel tensor is the same as the number of channels of the first feature map, and a length and width of the first convolution kernel tensor correspond to a preset size of the convolution kernel; and a weight determining submodule, configured to perform convolution processing on the first feature map according to the first convolution kernel tensor to obtain the weight feature map.

In a possible implementation, the weight determining submodule includes: a dilated convolution submodule, configured to perform dilated convolution on the first feature map according to the first convolution kernel tensor of the first feature map and a plurality of preset dilation rates to obtain a plurality of fourth feature maps of the first feature map; an activating submodule, configured to activate respectively the plurality of fourth feature maps to obtain a plurality of fifth feature maps; and a determining submodule, configured to determine the weight feature map of the first feature map according to the plurality of fifth feature maps.

In a possible implementation, the convolution kernel predicting submodule includes: a transforming submodule, configured to perform convolution transform respectively on the first feature maps to obtain key feature maps and query feature maps of the first feature maps, where a dimension of the key feature map is the same as the dimension of the first feature map, a length and width of the query feature map are the same as the length and width of the first feature map, and the number of channels of the query feature map corresponds to a size of the convolution kernel; a rearranging submodule, configured to perform rearrangement respectively on the key feature maps and the query feature maps to obtain a first feature matrix of the key feature maps and a second feature matrix of the query feature maps; a matrix multiplying submodule, configured to perform matrix multiplication on the first feature matrix and the second feature matrix to obtain a third feature matrix of the first feature map; and a tensor determining submodule, configured to determine the first convolution kernel tensor of the first feature map according to the third feature matrix.

In a possible implementation, the tensor determining submodule is configured to: perform rearrangement on the third feature matrix to obtain a second convolution kernel tensor of the first feature map; and perform normalization on the second convolution kernel tensor to determine the first convolution kernel tensor of the first feature map.

In a possible implementation, the adjusting module includes: an adjusting submodule, configured to perform element multiplication on the first feature map and the weight feature map to obtain the second feature map.

In a possible implementation, the apparatus further includes: a global pooling module, configured to perform global pooling on the first feature map to obtain a pooled feature map of the first feature map, where a dimension of the pooled feature map is the same as the dimension of the first feature map;

The result determining module includes: a fusing submodule, configured to perform fusion on the second feature map and the pooled feature map to obtain a fused feature map; and a first segmenting submodule, configured to perform segmentation on the fused feature map to obtain the processing result of the image to be processed.

In a possible implementation, the global pooling module includes: a pooling submodule, configured to perform pooling on the first feature map to obtain a first vector of the first feature map; a convolving submodule, configured to perform convolution on the first vector to obtain a second vector; and an upsampling submodule, configured to perform upsampling on the second vector to obtain the pooled feature map of the first feature map.

In a possible implementation, the result determining module includes: a second segmenting submodule, configured to perform segmentation on the second feature map to obtain the processing result of the image to be processed.

In some embodiments, functions or modules of the apparatus provided in the embodiments of the present disclosure may be used to execute the method described in the above method embodiments, which may be specifically implemented by referring to the above descriptions of the method embodiments, and are not repeated here for brevity.

An embodiment of the present disclosure further provides a computer readable storage medium having computer program instructions stored thereon, wherein the computer program instructions, when executed by a processor, implement the above method. The computer readable storage medium may be a non-volatile computer readable storage medium or volatile computer readable storage medium.

An embodiment of the present disclosure further provides an electronic device, which includes: a processor, and a memory, configured to store processor executable instructions, wherein the processor is configured to call the instructions stored in the memory to execute the above method.

An embodiment of the present disclosure further provides a computer program product, which includes computer readable codes; and when the computer readable codes are run on a device, a processor in the device executes the instructions for implementing the image processing method as provided in any of the above embodiments.

An embodiment of the present disclosure further provides another computer program product, which is configured to store computer readable instructions; and the instructions are executed to cause the computer to perform the operation of the image processing method as provided in any one of the above embodiments.

The electronic device may be provided as a terminal, a server or a device in any other form.

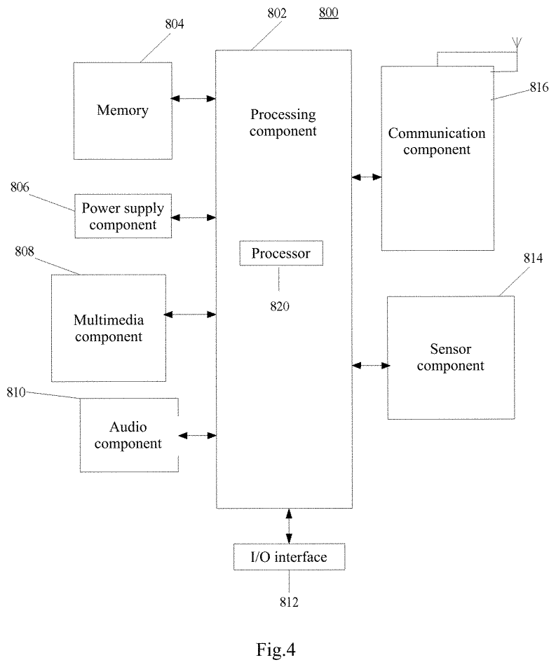

FIG. 4 illustrates a block diagram of an electronic device 800 according to an embodiment of the present disclosure. For example, the electronic device 800 may be a mobile phone, a computer, a digital broadcast terminal, a message transceiver, a game console, a tablet device, medical equipment, fitness equipment, a personal digital assistant or any other terminal.

Referring to FIG. 4, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls overall operations of the electronic device 800, such as operations related to display, phone call, data communication, camera operation and record operation. The processing component 802 may include one or more processors 820 to execute instructions so as to complete all or some steps of the above method. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage devices or a combination thereof, such as static random access memory (SRAM), electronic erasable programmable read-only memory (EEPROM), erasable programmable read-only memory (EPROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to the power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera. When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in the operating mode such as a call mode, a record mode and a voice identification mode, the microphone is configured to receive the external audio signal. The received audio signal may be further stored in the memory 804 or sent by the communication component 816. In some embodiments, the audio component 810 also includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to home buttons, volume buttons, start buttons and lock buttons.

The sensor component 814 includes one or more sensors which are configured to provide state evaluation in various aspects for the electronic device 800. For example, the sensor component 814 may detect an on/off state of the electronic device 800 and relative positions of the components such as a display and a small keyboard of the electronic device 800. The sensor component 814 may also detect the position change of the electronic device 800 or a component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a CMOS or CCD image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wire or wireless manner between the electronic device 800 and other devices. The electronic device 800 may access a wireless network based on communication standards, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to promote the short range communication. For example, the NFC module may be implemented on the basis of radio frequency identification (RFID) technology, infrared data association (IrDA) technology, ultrawide band (UWB) technology, Bluetooth (BT) technology and other technologies.

In exemplary embodiments, the electronic device 800 may be implemented by one or more application dedicated integrated circuits (ASIC), digital signal processors (DSP), digital signal processing device (DSPD), programmable logic device (PLD), field programmable gate array (FPGA), controllers, microcontrollers, microprocessors or other electronic elements and is used to execute the above method.

In an exemplary embodiment, there is further provided a non-volatile computer readable storage medium, such as a memory 804 including computer program instructions. The computer program instructions may be executed by a processor 820 of an electronic device 800 to implement the above method.

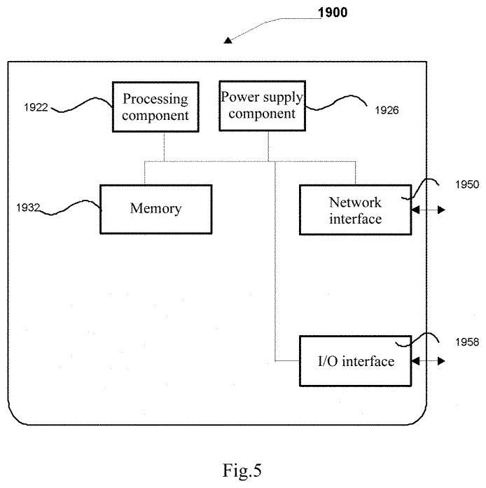

FIG. 5 illustrates a block diagram of an electronic device 1900 according to an embodiment of the present disclosure. For example, the electronic device 1900 may be provided as a server. Referring to FIG. 5, the electronic device 1900 includes a processing component 1922, and further includes one or more processors and memory resources represented by a memory 1932 and configured to store instructions executed by the processing component 1922, such as an application program. The application program stored in the memory 1932 may include one or more modules each corresponding to a group of instructions. Furthermore, the processing component 1922 is configured to execute the instructions so as to execute the above method.

The electronic device 1900 may further include a power supply component 1926 configured to perform power supply management on the electronic device 1900, a wire or wireless network interface 1950 configured to connect the electronic device 1900 to a network, and an input/output (I/O) interface 1958. The electronic device 1900 may run an operating system stored in the memory 1932, such as Windows Server™, Mac OS X™, Unix™, Linux™, FreeBSD™ or the like.

In an exemplary embodiment, there is further provided a non-volatile computer readable storage medium, such as a memory 1932 including computer program instructions. The computer program instructions may be executed by a processing module 1922 of an electronic device 1900 to execute the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium may be a tangible device that may retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein may be downloaded to individual computing/processing devices from a computer readable storage medium or to an external computer or external storage device via network, for example, the Internet, local region network, wide region network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local region network (LAN) or wide region network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, may be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, may be implemented by dedicated hardware-based systems performing the specified functions or acts, or by combinations of dedicated hardware and computer instructions.

The computer program product may be implemented specifically by hardware, software or a combination thereof. In an optional embodiment, the computer program product is specifically embodied as a computer storage medium. In another optional embodiment, the computer program product is specifically embodied as a software product, such as software development kit (SDK) and the like.

On the premise of not violating the logic, different embodiments of the present disclosure may be combined with one another. Different embodiments may describe different aspects. For the emphasized description, please refer to the records of other embodiments.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An imaging processing method, comprising:
performing feature extraction on an image to be processed to obtain a first feature map of the image to be processed;
performing weight prediction on the first feature map to obtain a weight feature map of the first feature map, the weight feature map including weight values of feature points in the first feature map;
performing feature value adjustment on the feature points in the first feature map according to the weight feature map to obtain a second feature map; and
determining a processing result of the image to be processed according to the second feature map.

2. The method according to claim 1, wherein the performing the weight prediction on the first feature map to obtain the weight feature map of the first feature map comprises:
performing convolution kernel prediction on each channel of the first feature map to determine a first convolution kernel tensor of the first feature map, wherein a number of channels of the first convolution kernel tensor is the same as a number of channels of the first feature map, and a length and a width of the first convolution kernel tensor correspond to a preset size of the convolution kernel; and
performing convolution processing on the first feature map according to the first convolution kernel tensor to obtain the weight feature map.

3. The method according to claim 2, wherein the performing the convolution processing on the first feature map according to the first convolution kernel tensor to obtain the weight feature map comprises:
performing dilated convolution on the first feature map according to the first convolution kernel tensor of the first feature map and a plurality of preset dilation rates to obtain a plurality of fourth feature maps of the first feature map;
activating the plurality of fourth feature maps respectively to obtain a plurality of fifth feature maps; and
determining the weight feature map of the first feature map according to the plurality of fifth feature maps.

4. The method according to claim 2, wherein the performing the convolution kernel prediction on each channel of the first feature map to obtain the first convolution kernel tensor of the first feature map comprises:
performing convolution transform on first feature maps respectively to obtain key feature maps and query feature maps of the first feature maps, wherein a dimension of the key feature map is the same as a dimension of the first feature map, a length and a width of the query feature map are the same as the length and the width of the first feature map, and a number of channels of the query feature map corresponds to a size of the convolution kernel;
performing rearrangement respectively on the key feature maps and the query feature maps to obtain a first feature matrix of the key feature maps and a second feature matrix of the query feature maps;
performing matrix multiplication on the first feature matrix and the second feature matrix to obtain a third feature matrix of the first feature map; and
determining the first convolution kernel tensor of the first feature map according to the third feature matrix.

5. The method according to claim 4, wherein the determining the first convolution kernel tensor of the first feature map according to the third feature matrix comprises:
performing rearrangement on the third feature matrix to obtain a second convolution kernel tensor of the first feature map; and
performing normalization on the second convolution kernel tensor to determine the first convolution kernel tensor of the first feature map.

6. The method according to claim 1, wherein the performing the feature value adjustment on
the feature points in the first feature map according to the weight feature map to obtain the second feature map comprises:
performing element multiplication on the first feature map and the weight feature map to obtain the second feature map.

7. The method according to claim 1, wherein the method further comprises:
performing global pooling on the first feature map to obtain a pooled feature map of the first feature map, wherein a dimension of the pooled feature map is the same as a dimension of the first feature map;
the determining the processing result of the image to be processed according to the second feature map comprises:
performing fusion on the second feature map and the pooled feature map to obtain a fused feature map; and
performing segmentation on the fused feature map to obtain the processing result of the image to be processed.

8. The method according to claim 7, wherein the performing the global pooling on the first feature map to obtain the pooled feature map of the first feature map comprises:
performing pooling on the first feature map to obtain a first vector of the first feature map;
performing convolution on the first vector to obtain a second vector; and
performing upsampling on the second vector to obtain the pooled feature map of the first feature map.

9. The method according to claim 1, wherein the determining the processing result of the image to be processed according to the second feature map comprises:
performing segmentation on the second feature map to obtain the processing result of the image to be processed.

10. An imaging processing apparatus, comprising:
a processor; and
a memory configured to store processor executable instructions,
wherein the processor is configured to call the instructions stored in the memory to:
performing feature extraction on an image to be processed to obtain a first feature map of the image to be processed;
performing weight prediction on the first feature map to obtain a weight feature map of the first feature map, the weight feature map including weight values of feature points in the first feature map;
performing feature value adjustment on the feature points in the first feature map according to the weight feature map to obtain a second feature map; and
determining a processing result of the image to be processed according to the second feature map.

11. The apparatus according to claim 10, wherein the weight prediction comprises:
performing convolution kernel prediction on each channel of the first feature map to determine
a first convolution kernel tensor of the first feature map, wherein a number of channels of the first convolution kernel tensor is the same as a number of channels of the first feature map, and
a length and a width of the first convolution kernel tensor correspond to a preset size of the convolution kernel; and
performing convolution processing on the first feature map according to the first convolution kernel tensor to obtain the weight feature map.

12. The apparatus according to claim 11, wherein the performing the convolution processing to obtain the weight feature map comprises:
performing dilated convolution on the first feature map according to the first convolution kernel tensor of the first feature map and a plurality of preset dilation rates to obtain a plurality of fourth feature maps of the first feature map;
activating respectively the plurality of fourth feature maps to obtain a plurality of fifth feature maps; and
determining the weight feature map of the first feature map according to the plurality of fifth feature maps.

13. The apparatus according to claim 11, wherein the convolution kernel prediction comprises:
performing convolution transform respectively on first feature maps to obtain key feature maps and query feature maps of the first feature maps, wherein a dimension of the key feature map is the same as a dimension of the first feature map, a length and a width of the query feature map are the same as the length and the width of the first feature map, and a number of channels of the query feature map corresponds to a size of the convolution kernel;
performing rearrangement on the key feature maps and the query feature maps respectively to obtain a first feature matrix of the key feature maps and a second feature matrix of the query feature maps;
performing matrix multiplication on the first feature matrix and the second feature matrix to obtain a third feature matrix of the first feature map; and
determining the first convolution kernel tensor of the first feature map according to the third feature matrix.

14. The apparatus according to claim 13, wherein the determining the first convolution kernel tensor comprises:
performing rearrangement on the third feature matrix to obtain a second convolution kernel tensor of the first feature map; and
performing normalization on the second convolution kernel tensor to determine the first convolution kernel tensor of the first feature map.

15. The apparatus according to claim 10, wherein the performing feature value adjustment on the feature points in the first feature map comprises:
performing element multiplication on the first feature map and the weight feature map to obtain the second feature map.

16. The apparatus according to claim 10, wherein the processor is configured to call the instructions to further:
perform global pooling on the first feature map to obtain a pooled feature map of the first feature map, wherein a dimension of the pooled feature map is the same as a dimension of the first feature map; and
the determining a processing result of the image to be processed comprises:
performing fusion on the second feature map and the pooled feature map to obtain a fused feature map; and
performing segmentation on the fused feature map to obtain the processing result of the image to be processed.

17. The apparatus according to claim 16, wherein the performing global pooling comprises:
performing pooling on the first feature map to obtain a first vector of the first feature map;
performing convolution on the first vector to obtain a second vector; and
performing upsampling on the second vector to obtain the pooled feature map of the first feature map.

18. The apparatus according to claim 10, wherein the determining a processing result of the image to be processed comprises:
performing segmentation on the second feature map to obtain the processing result of the image to be processed.

19. A computer readable storage medium having computer program instructions stored thereon, wherein the computer program instructions, when executed by a processor, implement the method comprising:
performing feature extraction on an image to be processed to obtain a first feature map of the image to be processed;
performing weight prediction on the first feature map to obtain a weight feature map of the first feature map, the weight feature map including weight values of feature points in the first feature map;
performing feature value adjustment on the feature points in the first feature map according to the weight feature map to obtain a second feature map; and
determining a processing result of the image to be processed according to the second feature map.
